(19) United States
(12) Patent Application Publication
(10) Pub. No.: US 2004/0108857 A1
(43) Pub. Date: Jun. 10, 2004

(54) Ionization detectors

(76) Inventors: Paul Jarski, Fargo, ND (US); Daniel Engebretson, Fargo, ND (US); Brian Very, Fargo, ND (US)

Correspondence Address: Stuart R. Hemphill, Esq., Dorsey & Whitney LLP, Intellectual Property Department, 50 South Sixth Street, Suite 1500, Minneapolis, MN, 55402-1498, US

(21) Appl. No.: 10/624,530

(22) Filed: Jul. 23, 2003

Related U.S. Application Data
(60) Provisional application No. 60/397,615, filed on Jul. 23, 2002.

(51) Int. Cl. G01N 27/62

(52) U.S. Cl. 324/464

(57) ABSTRACT

This invention relates to ionization detectors in which the direction of propagation of the radiation beam is co-linear to the direction of flow of the sample fluid of interest. In one embodiment, the ionization detector comprises an ionization chamber, a first electrode, a second electrode, and an optical window. The first and second electrodes are capable of forming an electrical field in the ionization chamber. The ionization chamber allows a sample fluid to flow through. The optical window is configured to allow a radiation beam to enter the ionization chamber in a direction that is co-linear to a direction of flow of the sample fluid in the ionization chamber. Preferably, the radiation beam is generated by a laser, such as a pulsed UV microchip laser, and molecules in the sample fluid are ionized through resonance-enhanced multiphoton ionization.

The present application claims priority from U.S. Provisional Application Serial No. 60/397,615, entitled “Ionization Detectors” and filed Jul. 23, 2002, the disclosure of which is incorporated herein by reference in its entirety.

### TECHNICAL FIELD

This invention relates to ionization detectors in which the direction of propagation of the radiation beam is co-linear to the direction of flow of the sample fluid.

### BACKGROUND OF THE INVENTION

Photoionization detectors (PID) can quantitatively measure the concentration of an analyte of interest in a gaseous sample. A traditional PID includes a ultraviolet (UV) lamp and an ionization chamber. The UV photons produced by the UV lamp enter the ionization chamber and ionize molecules with ionization potentials less than or equal to the energy level of the UV photons. The ionized molecules can be collected by electrically biased electrodes disposed in the ionization chamber. Signals thus generated can be used to determine the concentration of the analyte of interest in the gaseous sample. In conventional PIDs, the direction of the ionizing UV light is usually perpendicular to the direction of flow of the gaseous sample.

PIDs have many pitfalls when used as gas chromatography detectors for the analysis of fuels or other complex samples. For instance, PIDs may lack sufficient specificity to adequately discriminate the peaks of the aromatic species from the background signals of other species in the sample. PID detectors may require tedious pre-concentration steps (e.g., purge-and-trap) in order to analyze samples containing benzene and other aromatics, particularly when these aromatics are present near their regulatory limits in the samples. In addition, PIDs may lose additional sensitivity when operated as standalone organic vapor analyzers. PIDs are also known to be susceptible to interferences from water vapor, methane, and oxygen. Furthermore, PIDs have not been successfully implemented for analyzing eluates of liquid chromatography.

Therefore, there is a need to provide an ionization detector which has improved sensitivity and selectivity for aromatic compounds. There is also a need to provide an ionization detector that is more tolerant of gases other than the analytes of interest in a gaseous sample.

### SUMMARY OF THE INVENTION

This invention provides an ionization detector which has enhanced sensitivity and selectivity for detecting aromatic compounds under certain conditions.

In accordance with one aspect of the present invention, the ionization detector comprises an ionization chamber, a first electrode, a second electrode, and an optical window. The first and second electrodes are capable of forming an electrical field in the ionization chamber. The ionization chamber is configured to allow a sample fluid to flow through. The optical window allows a radiation beam to enter the ionization chamber and ionize molecules in the sample fluid. A direction of propagation of the radiation beam in the ionization chamber is co-linear to a direction of flow of the sample fluid in the ionization chamber.

In a preferred embodiment, the ionization detector further comprises a laser, such as a pulsed UV microchip laser. The radiation beam is a laser beam generated by the laser. The analyte of interest is ionized in the ionization chamber through resonance-enhanced multiphoton ionization.

In another preferred embodiment, at least a portion of each of the two electrodes forms an area of the interior surface of the ionization chamber. The sample fluid may be a gaseous or liquid sample, and the ionization detector may be coupled to a gas or liquid chromatograph.

In one embodiment, the negatively biased electrode is recessed in the ionization chamber in order to reduce the generation of photoelectrons.

In another embodiment, the electrical field produced by the two electrodes is substantially perpendicular to the directions of the sample fluid flow and the radiation beam.

In accordance with another aspect of the present invention, a method is provided for ionizing a sample fluid in an ionization chamber. The method comprises generating an electrical field in the ionization chamber and directing a radiation beam into the ionization chamber such that a direction of propagation of the radiation beam in the ionization chamber is co-linear to a direction of flow of the sample fluid in the ionization chamber. Preferably, the radiation beam is generated by a laser, such as a pulsed UV microchip laser.

Other features, objects, and advantages of the present invention are apparent in the detailed description that follows. It should be understood, however, that the detailed description, while indicating preferred embodiments of the invention, are given by way of illustration only, not limitation. Various changes and modifications within the spirit and scope of the invention will become apparent to those skilled in the art from the detailed description.

### BRIEF DESCRIPTION OF DRAWINGS

The drawings are provided for illustration, not limitation.

FIG. 1 shows an exploded top view of an ionization cell of the present invention.

FIG. 2 depicts an end view of the assembled cell.

FIG. 3 illustrates a side view of the cell.

FIG. 4 is a top view of the cell with assembled electrodes.

FIG. 5 provides a dimensioned end view of the cell.

FIG. 6 depicts a dimensioned side view of the cell.

FIG. 7 shows a dimensioned top view of the cell.

FIG. 8 is a dimensioned bottom view of the cell.

FIG. 9 illustrates the components of a winder holder of the cell.

FIG. 10 illustrates the dimension of the positively biased and negatively biased electrodes.

FIG. 11 demonstrates the components of an electrode assembly of the cell.

FIG. 12 shows toluene chromatograms collected using an ionization detector of the present invention.

FIG. 13 depicts toluene chromatograms detected using an ionization detector of the present invention.

FIG. 14 shows the selectivity of an ionization detector of the present invention for detecting toluene versus pentane.

FIG. 15A illustrates a BTEX chromatogram measured using a traditional PID.

FIG. 15B represents a BTEX chromatogram measured using an ionization detector of the present invention.

FIG. 16A is a gas chromatogram of a naphtha diluted sample measured using a traditional PID.

FIG. 16B shows a gas chromatogram of a naphtha diluted sample measured using an ionization detector of the present invention.

FIG. 17A depicts a gas chromatogram of an undiluted sample of mineral spirits measured using a traditional PID.

FIG. 17B illustrates a gas chromatogram of an undiluted sample of mineral spirits measured using an ionization detector of the present invention.

FIG. 18A is a gas chromatogram of an unleaded gasoline solution in pentane detected using a traditional PID.

FIG. 18B shows a gas chromatogram of an unleaded gasoline solution in pentane detected using an ionization detector of the present invention.

### DETAILED DESCRIPTION

In accordance with one aspect of the present invention, the ionization detector comprises an ionization chamber, an inlet, and an outlet. A sample fluid can enter the ionization chamber through the inlet, and exit the chamber through the outlet. The sample fluid can be driven through the ionization chamber by positive pressure at the sample supply, by carrier gas/solvent, by a controller controlling valves or gates in the detector, or by other means as appreciated by one of skill in the art.

The ionization detector also has two electrodes, one being electrically biased to attract negatively charged particles and the other being electrically biased to attract positively charged particles. These two electrodes are capable of creating an electrical field in the ionization chamber, thereby causing ionized molecules to travel to the corresponding electrode to produce an electrical signal. The electrodes can be prepared from various metals or alloys, such as stainless steel or copper. The electrodes can also be made by depositing a conductive layer on a substrate. Other means for making suitable electrodes are known in the art.

The ionization detector further includes an optical window through which a radiation beam can enter the ionization chamber and ionize the molecules in the sample fluid. Suitable optical windows which allow the transmission of different wavelengths of radiation are known in the art. The direction of propagation of the radiation beam in the ionization chamber is co-linear to a direction of flow of the sample fluid in the ionization chamber. As used herein, a direction of propagation of a light beam is co-linear to a direction of flow of a fluid if the acute angle between the path of the light beam and the path of the fluid flow is less than 20 degrees. Preferably, the acute angle between the path of the light beam and the path of the fluid flow is less than 5 degrees. More preferably, the acute angle between the path of the light beam and the path of the fluid flow is less than 1 degree. Most preferably, the acute angle between the path of the light beam and the path of the fluid flow is zero degree, i.e., the radiation beam and the sample fluid travel either in the same direction or in opposite directions.

This co-linear arrangement increases the interaction region between the radiation beam and the sample fluid in the ionization chamber and reduces the dead volume in the ionization chamber. In a preferred embodiment, the ionization chamber has an elongated configuration to increase the length through which the sample fluid flows from the inlet to the outlet. The radiation beam is co-linear to the sample fluid flow such that the radiation beam interacts with the sample fluid throughout the longitudinal length of the elongated ionization chamber. This configuration increases both the interaction volume and the interaction time between the radiation beam and the sample fluid, thereby increasing the chance of ionization of the analytes of interest in the ionization chamber. The electrodes may also have an elongated configuration and are aligned along the longitudinal direction of the ionization chamber. The elongated electrodes may take at least 50% of the longitudinal length of the ionization chamber. Preferably, the elongated electrodes take at least 75% of the longitudinal length of the ionization chamber. For instance, the electrodes can take about 80%, 90%, 95% or 98% of the longitudinal length of the ionization chamber. The extended shape of the electrodes increases the effective path length of the ionization chamber, thereby increasing the chance of an ionized molecule being captured by the electrodes.

The electrically biased electrodes and the radiation beam can be arranged such that the beam does not hit the electrodes directly, thereby reducing photoelectrons released from the electrodes.

Preferably, the electrical field between the two electrodes is substantially perpendicular to the path of the radiation beam and the path of the sample fluid flow. As used herein, “substantially perpendicular” means that the acute angle between two directions is between 80 and 90 degrees, preferably between 85 and 90 degrees, and more preferably between 89 and 90 degrees. Most preferably, the electrical field is perpendicular (i.e. 90 degrees) to the paths of the radiation beam and the sample fluid flow.

A variety of radiation sources can be used to produce the radiation beam of the present invention. Suitable radiation sources include UV lamps, X-ray or gamma-ray sources, radioactive materials capable of emitting non-photon particles, or preferably, solid-state lasers, such as microchip lasers. An example of microchip lasers is a single-crystal bulk laser device that emits coherent radiation upon stimulation by an external light source. The external light source can be a pump laser, such as a diode laser or a diode laser array. Suitable microchip lasers with selected output wavelengths are known in the art. A temperature control system may be coupled to the microchip laser to stabilize the temperature and therefore the optical output frequency of the laser. An example of temperature control systems is described in U.S. Pat. No. 6,055,815. In a preferred embodiment, a pulsed UV(ultraviolet) microchip laser is used as the radiation source of the present invention.

Preferred sample fluids are gas samples. Examples of the analytes of interest for the present invention include organic compounds containing aromatic groups, such as benzene, toluene, ethylbenzene, and xylenes. Benzene, toluene, ethylbenzene and xylenes are collectively referred to as “BTEX.”

The wavelength of the pulsed UV laser can be chosen to match the absorbance profiles of the analytes of interest. At sufficiently high photon flux, some fraction of the excited molecules will absorb a second photon from the same laser pulse and become ionized. This process is known as resonance-enhanced multiphoton ionization (REMPI). See, for example, C. Klimcak and J. Wessel, “Gas Chromatography with Detection by Laser Excited Resonance Enhanced 2-Photon Photoionization,” Anal. Chem., 52, 1233-1239 (1980), which is incorporated herein by reference. The use of the pulsed UV microchip laser allows the detection of REMPI under both low pressure and ambient pressure conditions.

Various advantages are associated with using pulsed UV microchip lasers and REMPI to detect the analytes of interest. A microchip laser is small in size, offers high pulse repetition frequencies, has excellent focusability and shot-to-shot stability, and possesses extremely short pulse duration. The two-photon ionization mechanism further enhances the detection efficiency and selectivity as compared to the one-photon ionization mechanism used in traditional PIDs. In addition, the two-photon ionization has natural zero time for ion mobility or time-of-flight modes, and suffers less interference from air, water vapor, carrier or other gases. Another advantage of the present invention is that the pulsed UV microchip laser allows faster measurements than traditional PIDs. The laser can operate at several thousand pulses per second. The ionization detector of the present invention can measure at least every 0.1 seconds. The measurement time may be further reduced in liquid chromatography.

In one instance, the ionization detector of the present invention has a sensitivity of less than 2 pg/second for toluene. In another instance, the ionization detector of the present invention has a selectivity of more than 10⁷ for aromatic compounds (such as BTEX) versus aliphatic compounds. In yet another instance, the dynamic range of the ionization detector of the present invention is over 10⁵.

The signals collected by the biased electrodes can be detected using a current detector and processed using a processing circuit. A correlation between the electrical signals collected by the electrodes and the concentration or identity of the analytes of interest can be determined, as appreciated by one of ordinary skill in the art. An example of suitable processing circuits comprises an analog-to-digital converter (ADC) coupled to a computer processor. A controller circuit may also be coupled to the ionization detector of the present invention to coordinate the radiation source, the ionization process, and the collection and measurement of the ionized molecules.

The microchip laser-based ionization detector of the present invention can be used in various applications. For instance, it can be employed as a gas chromatography detector, a field analyzer, or a liquid chromatography detector. It can also be used in the drug discovery process by helping to introduce a large number of new drug candidates. Moreover, it enables quick identification of harmful aromatic hydrocarbons, such as benzene or BTEX. Aromatic hydrocarbons exist in fuels and may show up as contaminants in soil and groundwater. Combustion processes also generate carcinogenic or mutagenic polycyclic aromatic hydrocarbons. Some of these aromatic hydrocarbons may cause various forms of cancer and blood disorders, including acute nonlymphocytic leukemia and Hodgkin's lymphoma. The aromatic signals resulting from traditional detectors (such as PIDs or flame ionization detectors) tend to be masked by the aliphatic signals. The microchip laser-based ionization detector of the present invention increases the detection sensitivity for aromatic signals.

It should be understood that the above-described embodiments and the following examples are given by way of illustration, not limitation. Various changes and modifications within the spirit and scope of the present invention will become apparent to those skilled in the art from the present description.

### EXAMPLE 1

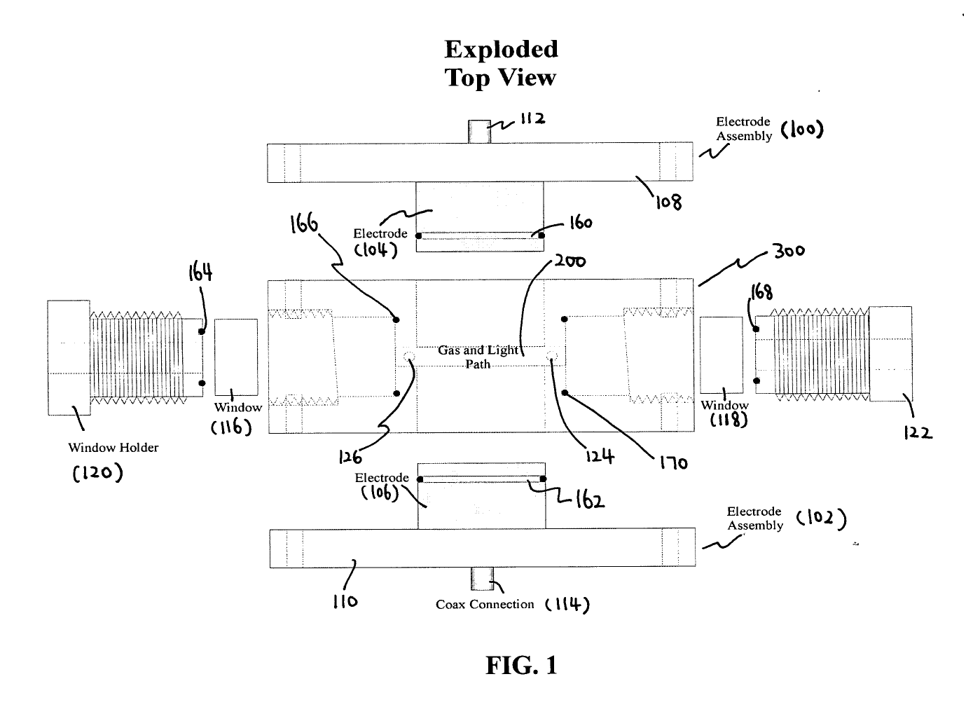

This example demonstrates an ionization cell design of the present invention. FIG. 1 shows an exploded top view of the ionization cell. The cell contains two electrode assemblies 100 and 102. The electrode assembly 100 includes an electrode 104 which is attached to a mounting plate 108 and a coaxial connector 112. Electrical signals gathered by the electrode 104 can be communicated to an external circuit through the coaxial connector 112. The electrode 104 has a recessed groove 160 to accept an o-ring thereby forming a gas tight seal when positioned in the cell body 300. The mounting plate 108 allows the electrode 104 to be easily removed from the cell body for inspection and cleaning. This mounting design also isolates the electrode 104 from the surroundings, thereby reducing background noises.

Similarly, the electrode assembly 102 includes an electrode 106 which is attached to a mounting plate 110 and a coaxial connector 114 through which the electrode can be electrically connected to an external circuit. The electrode 106 has a recessive groove 162 to accept an o-ring to form a tight seal when assembled into the cell body 300. In this example, the electrode 104 is a positively biased electrode, and the electrode 106 is a negatively biased electrode.

The radiation beam can enter the ionization chamber 200 through a first fused silica window 116 and exit the ionization chamber 200 through a second fused silica window 118. Windows 116 and 118 are secured to the ionization cell by window holders 120 and 122 respectively. Recessed o-ring grooves 164, 166, 168 and 170 are cut in both the window holders and the base of the cell bodies to form a gas tight seal. The diameter of the chamber 200 may be selected to be slightly larger than the diameter of the unfocused radiation beam. In this way, there is a certain leeway to position the radiation beam through the chamber 200 without impinging on either of the electrodes 104 and 106.

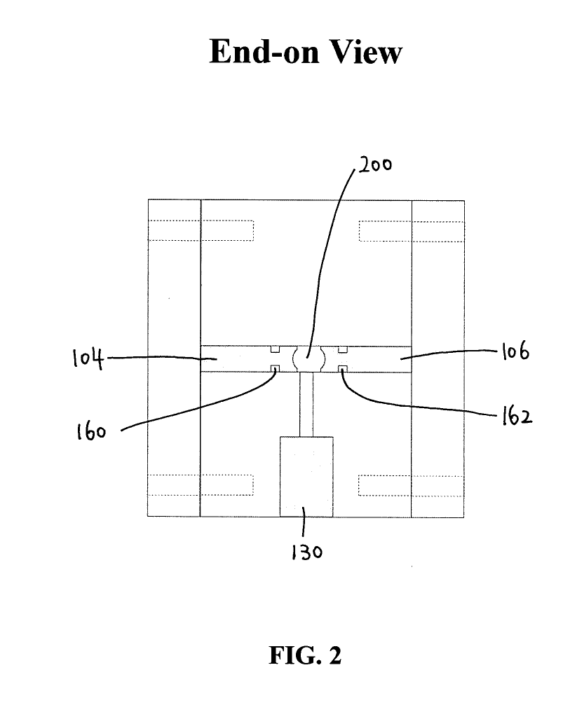

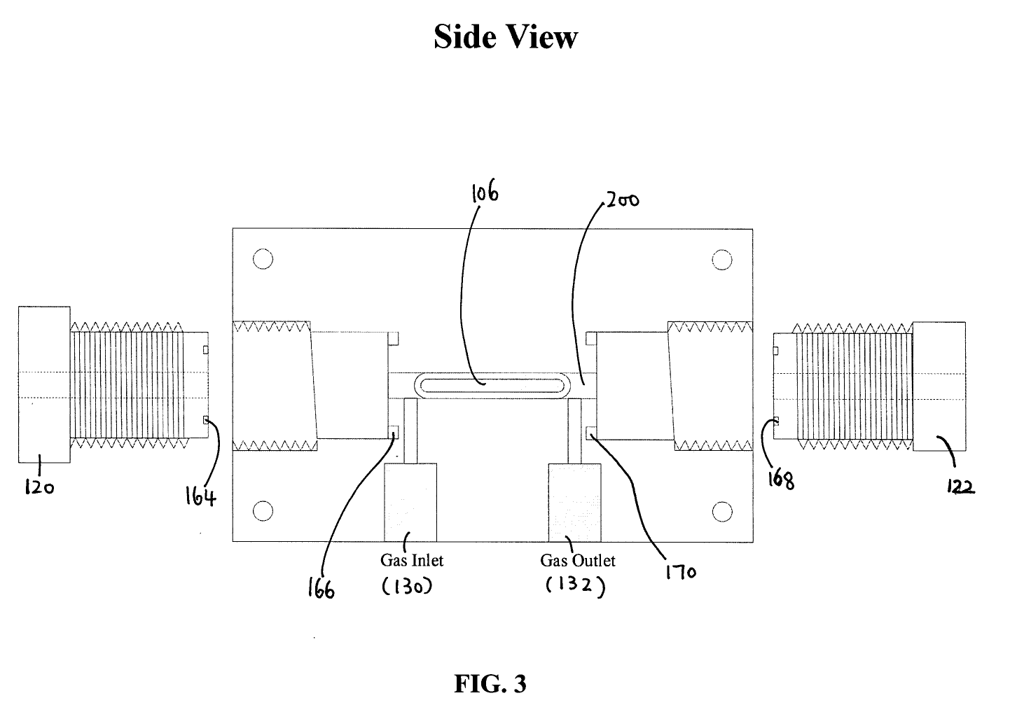

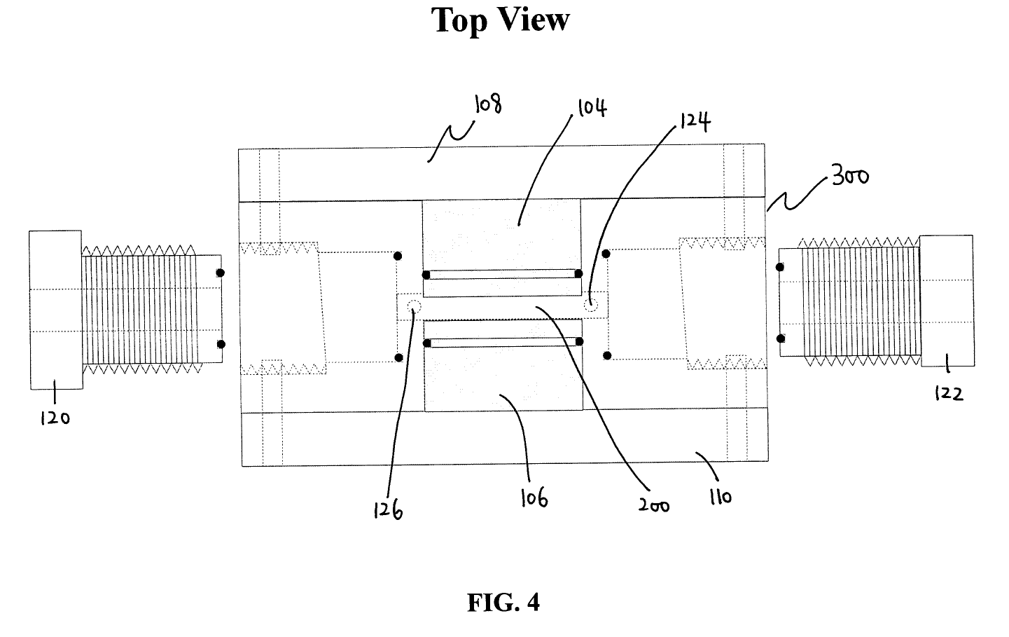

FIG. 2 is an end-on view of the assembled ionization cell. The electrodes 104 and 106 act as the interior walls of the ionization chamber 200. The electrodes 104 and 106 can be machined to create a desired shape of the walls of the chamber 200. This construction maximizes the vertical interaction region of the electrodes while minimizing the volume of the cell. The electrodes may be made to take about 75% of the longitudinal length of the ionization chamber, as shown in FIGS. 3 and 4.

A gaseous sample fluid can enter the ionization chamber through the gas inlet 130, and exit the chamber through the gas outlet 132. The inlet 130 and the outlet 132, illustrated in FIG. 3, are positioned toward the edges of the ionization chamber to minimize areas where eddies of gas could form. These two ports can be moved even further to the ends of the ionization chamber to reduce turbulent flow and dead volume. FIG. 2 shows the location of the inlet 130 from an end-on view. The inlet 130 is capable of communicating to the chamber 200 through hole 126, and the outlet 132 is capable of communicating to the chamber 200 through hole 124, as demonstrated in FIGS. 1 and 4.

The direction of flow of the sample fluid and the direction of propagation of the radiation beam are co-linear in the ionization chamber 200. Preferably, the sample fluid and the radiation beam travel in the same or in opposition directions in the ionization chamber 200.

FIG. 4 is a top view of the ionization cell with assembled electrodes. The black circles represent o-ring positions on the electrodes 104 and 106, the window holders 120 and 122, the window-receiving surface of the cell body 300. The ionization chamber 200 and holes 124 and 126 are also illustrated in FIG. 4.

As shown in FIG. 4, the negatively biased electrode 106 is slightly recessed so that the radiation beam is less likely to impinge directly on it, thereby reducing the possibility of photoelectron generation. In addition, when the electrode 106 is assembled into the cell, it is not in direct line of the radiation beam, further reducing the chance of photoelectron generation.

The dashed rectangles at each corner of the cell body 300 and the mounting plates 108 and 110 in FIG. 4 represent threaded holes for securing the electrode assemblies to the cell. These tapped holes may seem to intersect the window-receiving surfaces of the cell body, but do not in fact intersect the surfaces because of the curvature of the window holders.

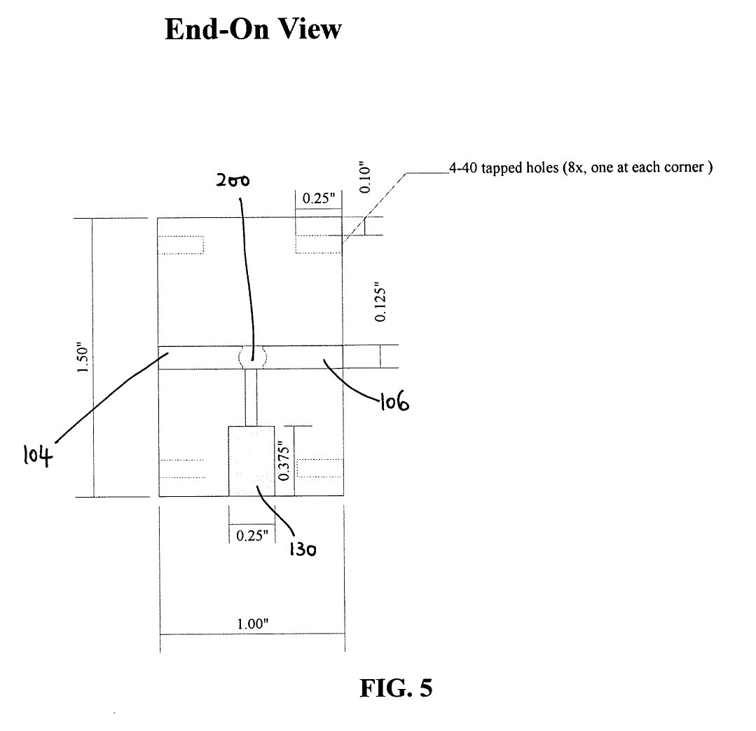

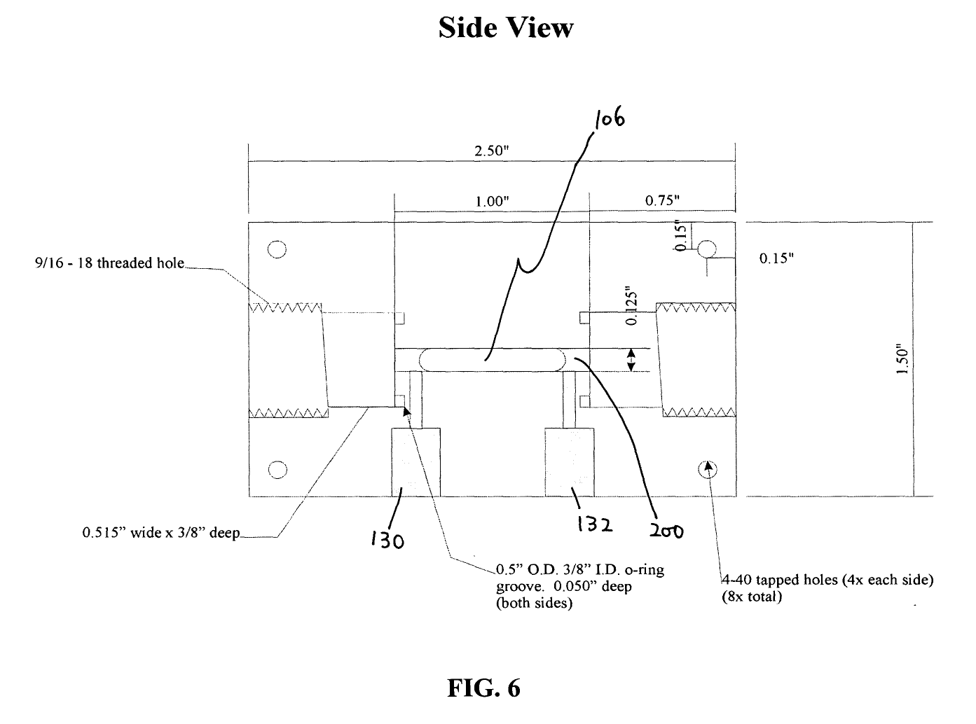

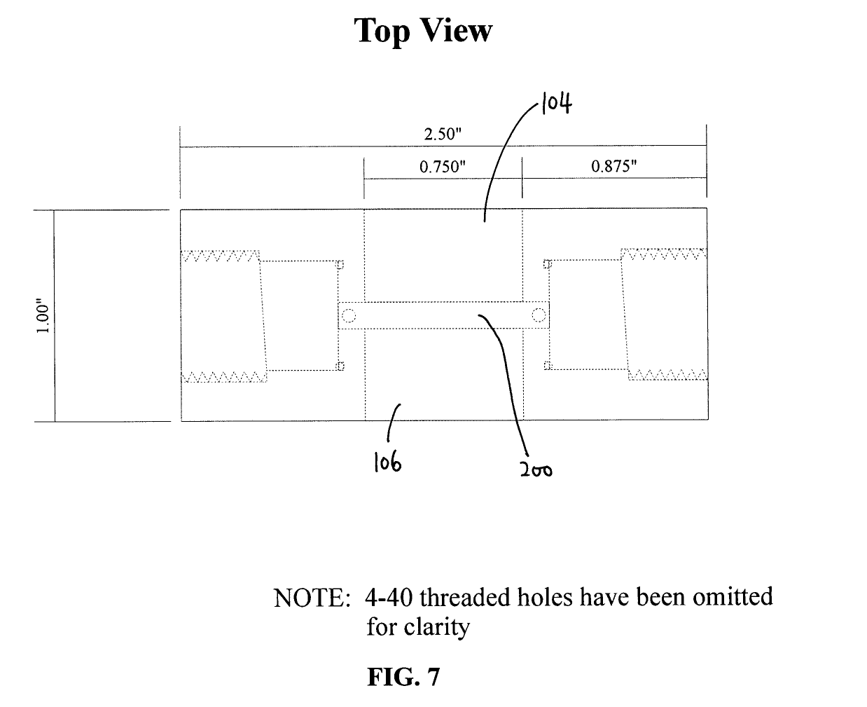

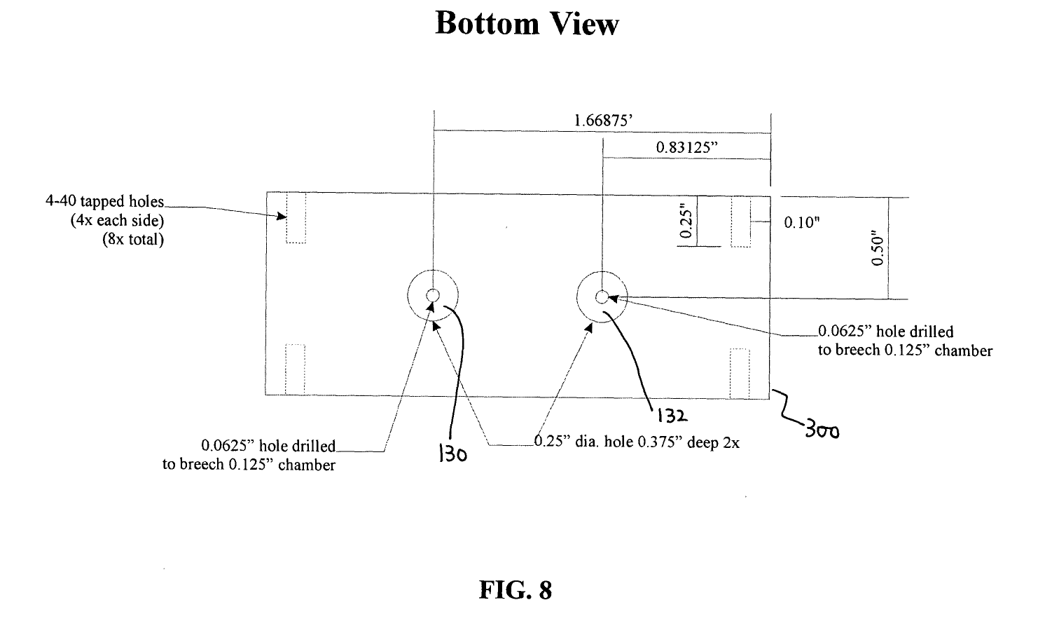

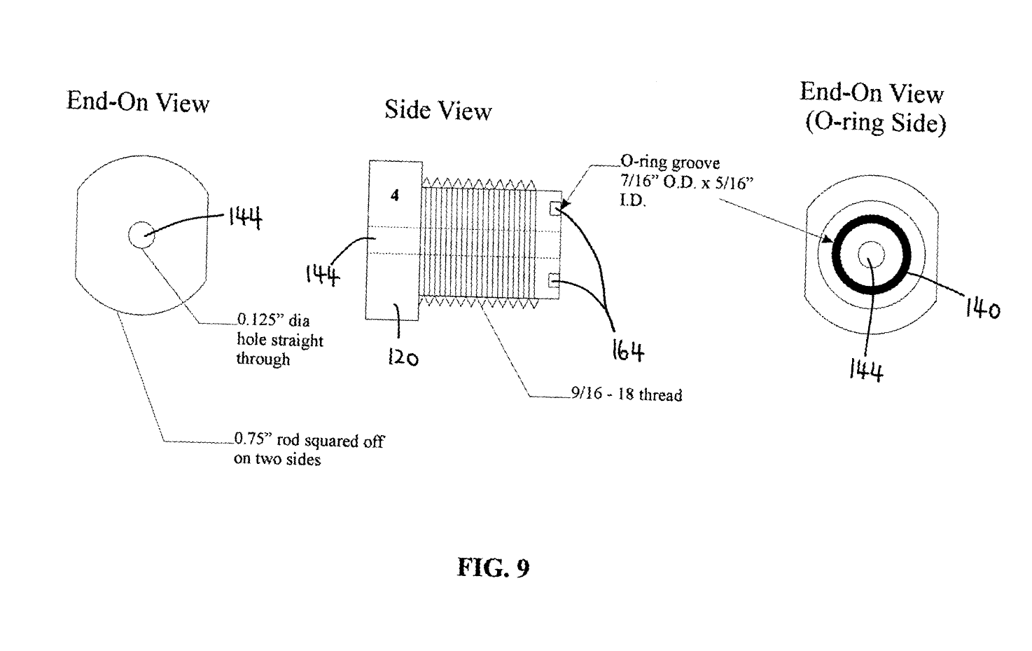

FIGS. 5, 6, 7, 8, 9 and 10 illustrate the dimension of various components of the ionization cell. FIG. 9 shows a channel 144 in the window holder 120 and an o-ring 140. The o-ring 140 is capable of being placed in the o-ring groove 164. The o-ring 140 serves at least two purposes, one to seal the cell and the other to protect the window from over tightening. The radiation beam can pass through the channel 144 and enter the ionization chamber 200.

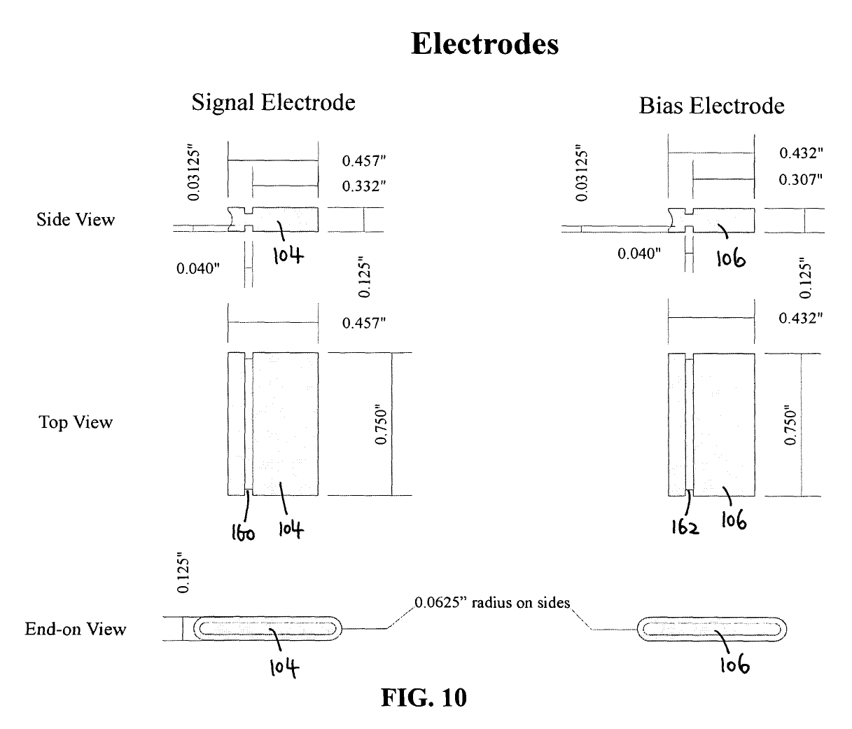

FIG. 10 depicts different views of the electrodes 104 and 106. The negatively biased electrode 106 (Bias Electrode) is lightly shorter than the electrode 104 (Signal Electrode). This allows the electrode 106 to be recessed with respect to the ionization chamber 200, thereby reducing the generation of photoelectrons. The front surface (the surface facing the ionization chamber 200) of each electrode is curved to the same radius as that of the chamber 200. This increases the effective collection surfaces of the electrodes. The elongated nature of the electrodes, as shown from the end-on view, increases the effective path length of the ionization chamber, thereby increasing the limit of detection of the cell compared to a cell designed to intersect the gas flow perpendicularly with the radiation beam.

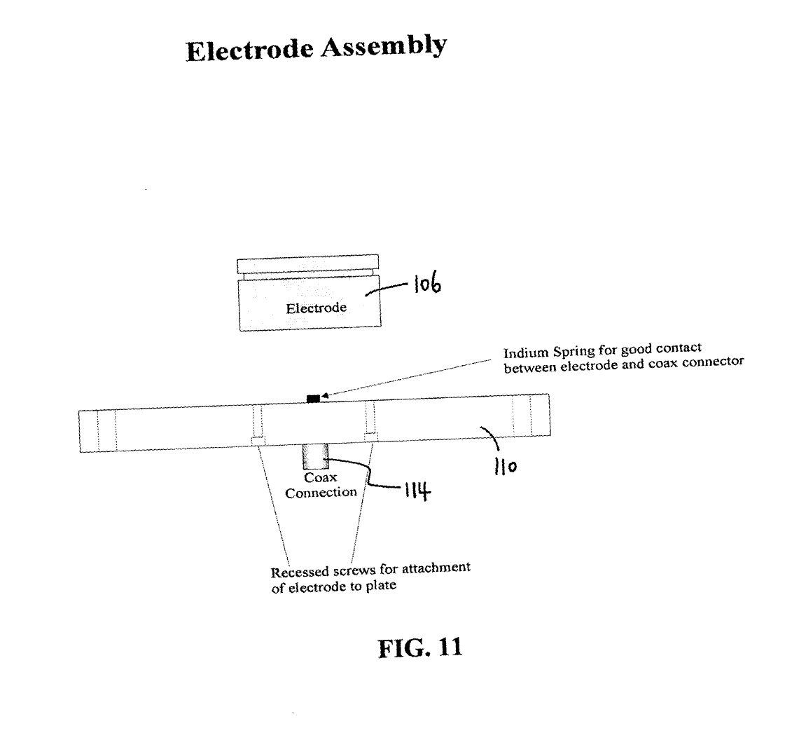

FIG. 11 shows the electrode assembly 102. The electrode 106 is connected to the coaxial connector 114 through a coiled piece of indium metal 150. The indium metal provides good contact between the coaxial connector 114 and the electrode 106. This arrangement allows the electrode to be easily removed from the mounting plate 110 for inspection, cleaning or other manipulations without necessitating any soldering or desoldering. The indium metal can be replaced by other conductive metals. The electrode 106 can be secured to the mounting plate with two screws that are recessed into the mounting plate.

### EXAMPLE 2

This example demonstrates the improved sensitivity and selectivity of the ionization cell of Example 1 when used to detect toluene and other aromatics. SRI GC systems (Torrance, Calif.) and Restek MXT-1 columns (15 meter, 0.53 mm I.D., Restek Corp (US), Bellefonte, Pa.) were employed to carry out the gas chromatography. The ionizing radiation beam is produced by a Synoptic microlaser quadrupled to 266 nm (Synoptics, Charlotte, N.C.). Carrier gas is air.

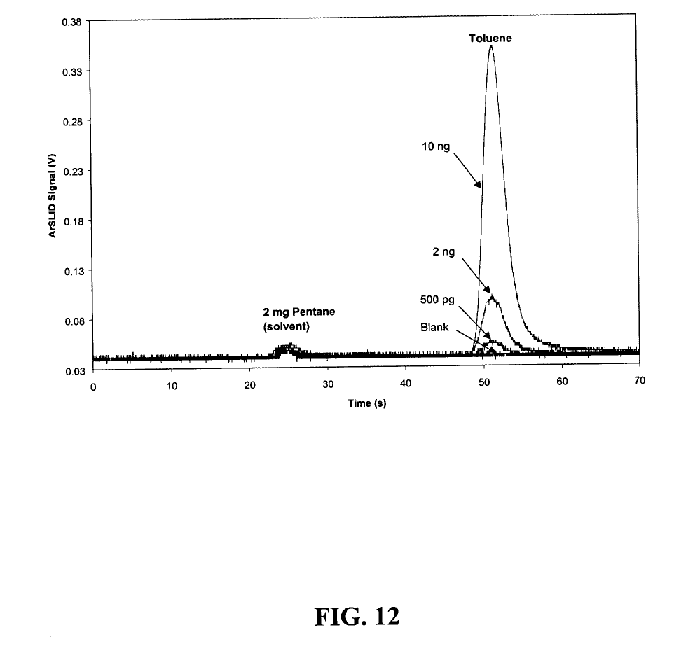

FIG. 12 shows toluene chromatograms measured using the ionization cell of Example 1. The samples were mixtures of pentane and toluene. 3 microliter aliquot of each sample was injected into a Restek MXT-1 column. The amount of toluene in each sample ranged from 500 pg to 10 ng. A sample without toluene (Blank) was also provided. The column had a flow rate of 20 ml/min, and was set to 40° C. isothermal. The electrode bias between the two electrodes in the ionization cell was 300 V. The integration time for each measurement was 10 ms. ArSLID refers to the signals gathered by the ionization cell of Example 1. FIG. 12 reveals distinct peaks for various amounts of toluene.

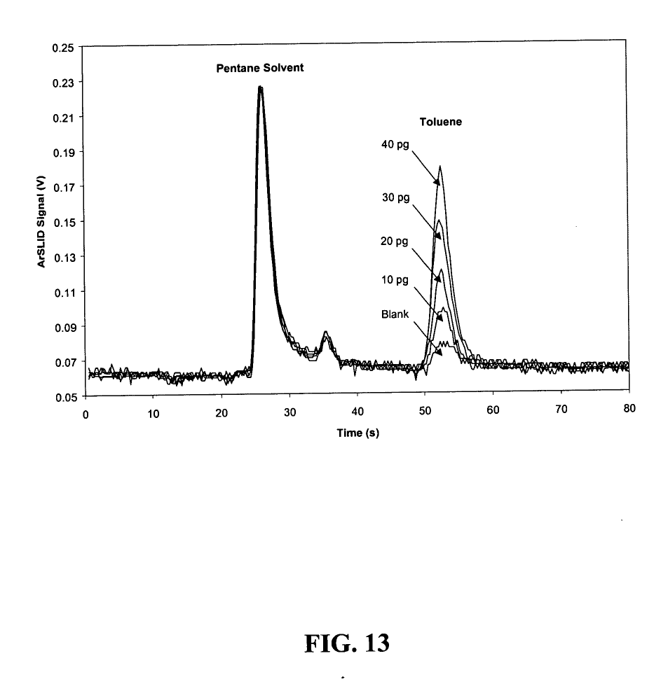

FIG. 13 illustrates the high detection sensitivity of the ionization cell of Example 1 for toluene. The measurement conditions were similar to those used in FIG. 12. The laser energy was 320 nJ per pulse. The integration time for each measurement was 250 ms. The amount of toluene in each sample ranged from 0 pg (Blank) to 40 pg. A distinct peak was detected for a sample containing as low as 10 pg toluene.

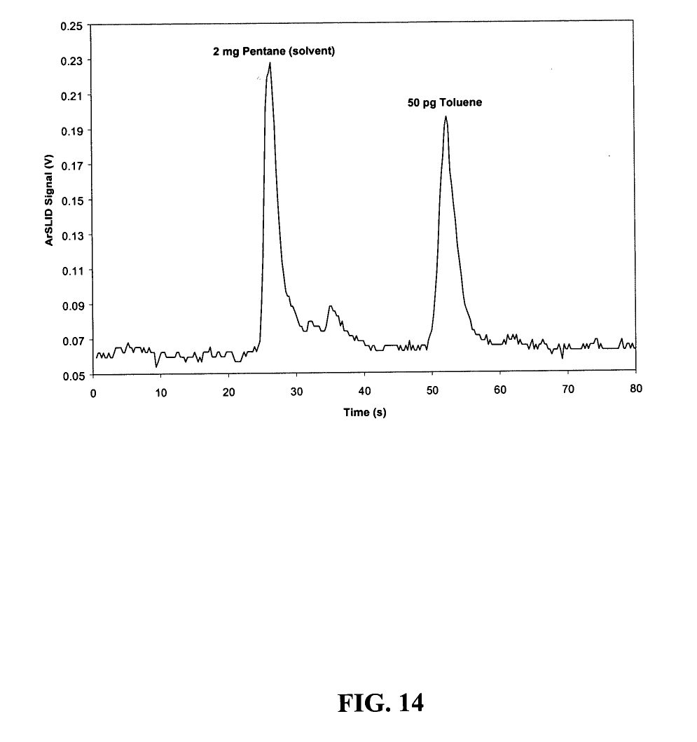

FIG. 14 demonstrates that the selectivity of the ionization cell of Example 1 for toluene versus pentane can be over 10^{7.} A mixture containing 2 mg pentane (solvent) and 50 pg toluene was injected into a Restek MXT-1 column. The measurement conditions were similar to those used in FIG. 13. The signal peaks for the 2 mg pentane and the 50 pg toluene were manifestly distinguishable.

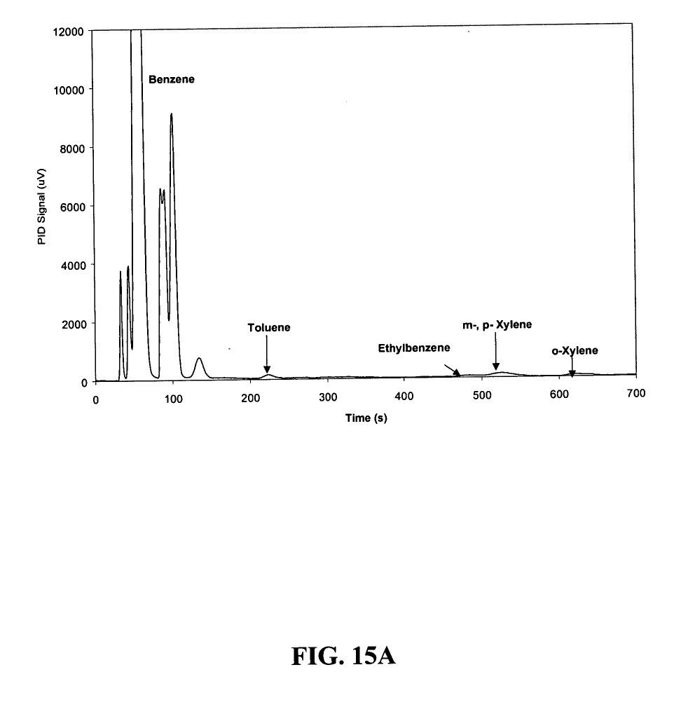

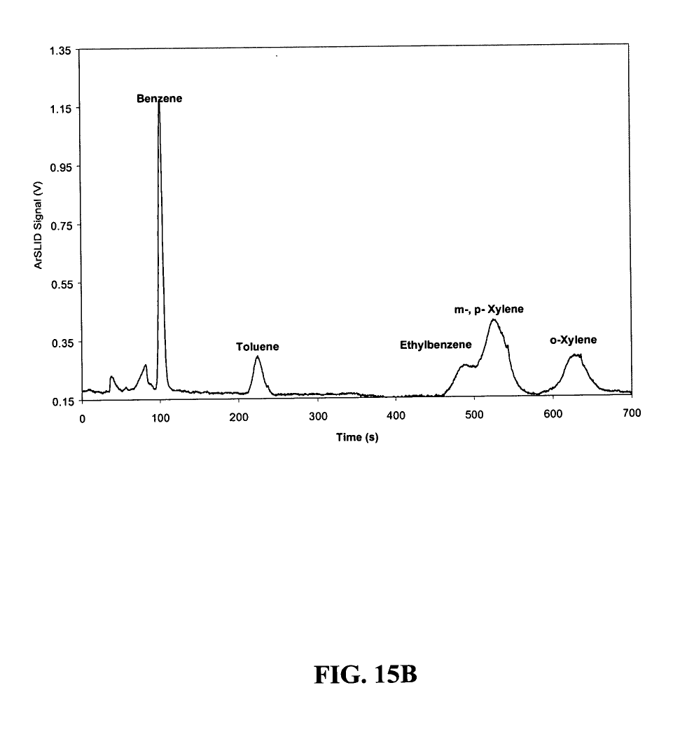

FIGS. 15A and 15B compare the detection sensitivity/selectivity of the ionization cell of Example 1 for BTEX, to a traditional PID. The sample was a dilute BTEX mixture in pentane, hexane and MTBE. Specifically, the sample contained 2 mg pentane, 11.1 μg MTBE, 131 ng benzene, 1.29 ng toluene, 1.30 ng ethylbenzene, 1.31 ng o-Xylene, 1.30 ng m-Xylene, and 1.30 ng p-Xylene. The temperature of the Restek MXT-1 column was set at 40° C. for 10 min, and then increased to 150° C. at 5° C./min. The flow rate of the column was 20 ml/min. The PID lamp current was set at 70 mA. The Synoptics microlaser, quadrupled to 266 mn, had an energy output of 320 nJ per pulse. The electrode bias in the ionization cell of Example 1 was 300 V.

FIG. 15A shows the PID signals. Most non-BTEX components were eluted within the first 150 seconds. The benzene signal was partially mixed with the solvent signals. The signals for toluene, ethylbenzene and xylenes were barely detectable as compared to the benzene signal.

In contrast, the ionization cell of the present invention produced a markedly improved signal profile for BTEX, as shown in FIG. 15B. Benzene was clearly distinguishable from the solvent signals. Toluene, ethylbenzene and xylenes also had noticeable signals as compared to that of benzene.

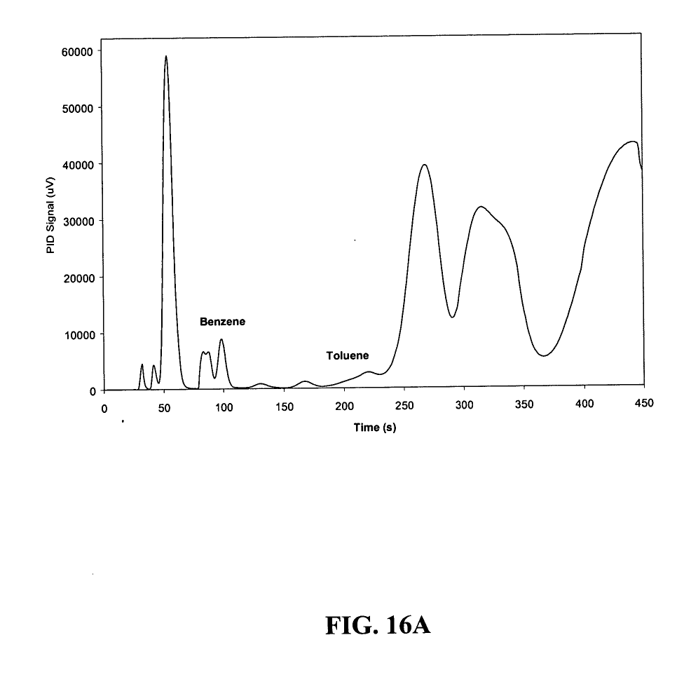

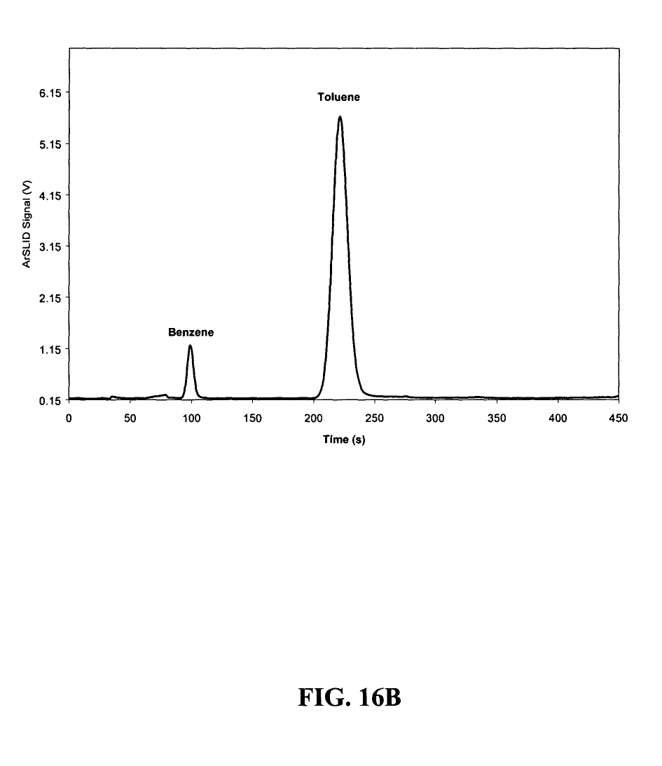

FIGS. 16A and 16B demonstrate the improved tolerance of the ionization cell of the present invention, as compared to the traditional PID, with respect to the interference created by aliphatic components. The measurement conditions for FIGS. 16A and 16B were similar to those used in FIG. 15A and 15B. Naphtha, a petroleum-based solvent, was diluted 10:1 in a mixture containing benzene and toluene. The sample thus made was injected into a Restek MXT-1 column. FIG. 16A shows the measurement using the traditional PID. Aliphatic components in the sample significantly interfered in the analysis of benzene and toluene when measured using the PID. In contrast, the measurement of the same sample using the ionization cell of the present invention produced a radically improved signal for the aromatic hydrocarbons, as shown in FIG. 16B.

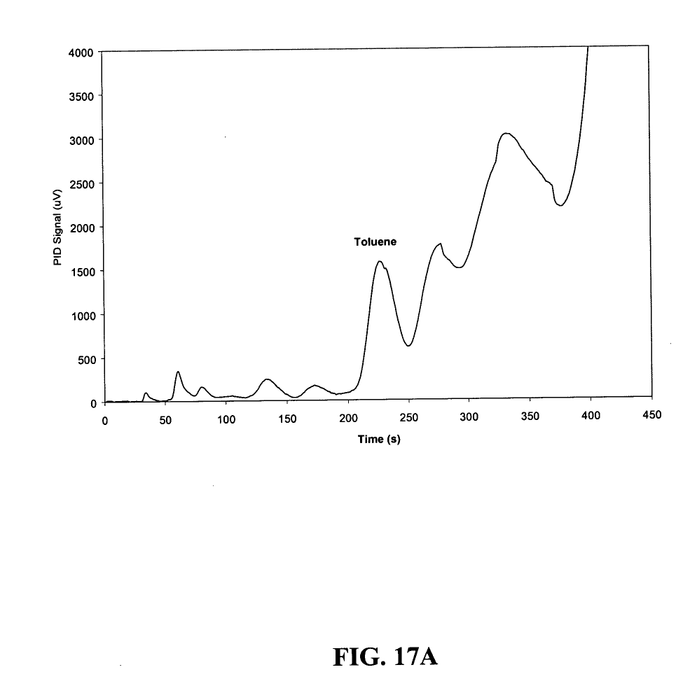

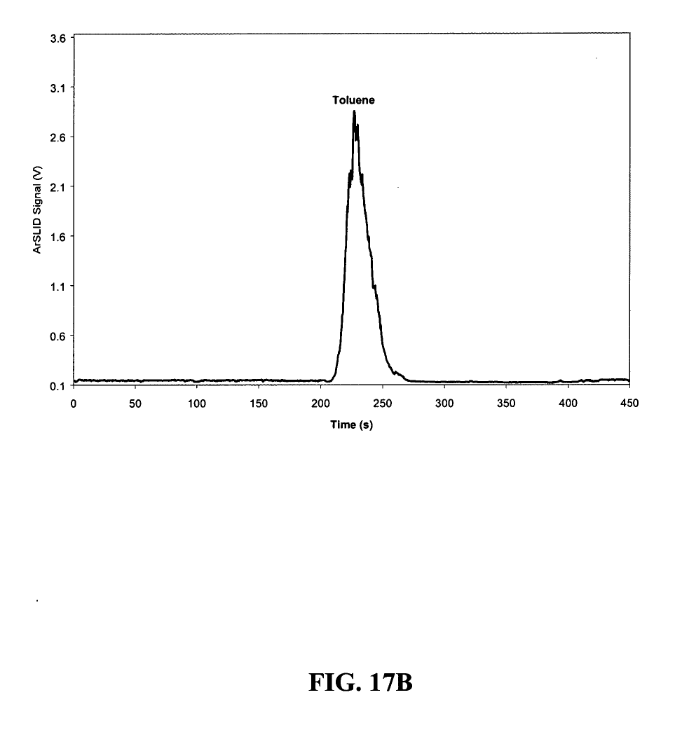

FIGS. 17A and 17B illustrates the selectivity advantage of the ionization cell of the present invention for the detection of toluene and other aromatic hydrocarbons. The sample used in FIGS. 17A and 17B was an undiluted sample of mineral spirits (a petroleum distillate product). The measurement conditions were similar to those used in FIGS. 16A and 16B. The traditional PID failed to selectively detect toluene in the sample. See FIG. 16A. In contrast, the ionization cell of the present invention provided a conspicuous toluene peak as compared to other signals. See FIG. 17B.

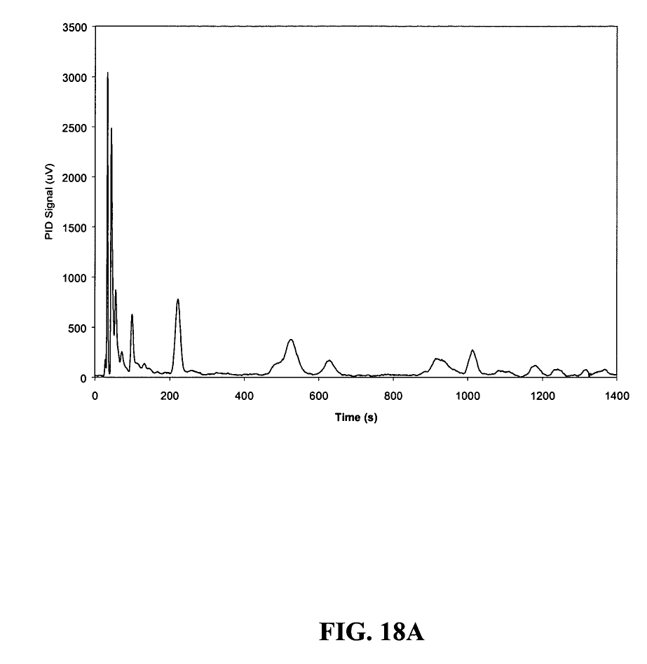

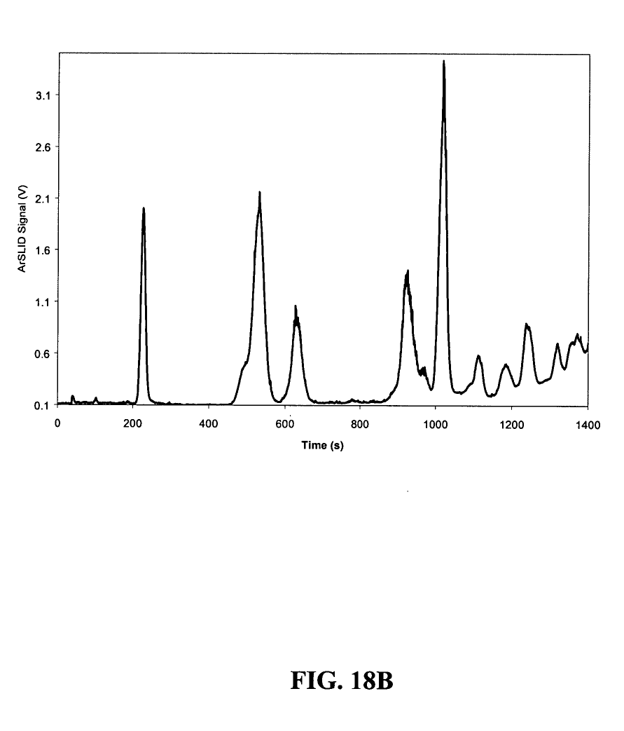

FIGS. 18A and 18B are the gas chromatography analysis of 100 ppm unleaded gasoline solution in pentane. The measurement conditions were similar to those used in FIGS. 17A and 17B. Most short chain aliphatics were eluted in the first 100 seconds. These short chain aliphatics produced significant signals when the sample was measured using the PED. See FIG. 18A. In contrast, these short chain aliphatics generated little noticeable signals when measured using the ionization cell of Example 1. In addition, FIG. 18B depicts more conspicuous aromatic component peaks than FIG. 18A does.

What is claimed is:

1. An ionization detector, comprising:
an ionization chamber configured to allow a sample fluid to flow through;
a first electrode;
a second electrode, the first and second electrodes capable of forming an electrical field in the ionization chamber; and
an optical window configured to allow a radiation beam to enter the ionization chamber, wherein a direction of propagation of the radiation beam in the ionization chamber is co-linear to a direction of flow of the sample fluid in the ionization chamber.

2. The ionization detector according to claim 1, further comprising a laser, wherein the radiation beam is a laser beam produced by the laser.

3. The ionization detector according to claim 2, wherein at least a portion of the first electrode forms a first area of an interior surface of the ionization chamber, and at least a portion of the second electrode forms a second area of the interior surface of the ionization chamber.

4. The ionization detector according to claim 3, wherein the sample fluid comprises gases.

5. A method for ionizing a sample fluid in an ionization chamber, comprising:
generating an electrical field in the ionization chamber;
directing a radiation beam into the ionization chamber such that a direction of propagation of the radiation beam in the ionization chamber is co-linear to a direction of flow of the sample fluid in the ionization chamber.
